(19) United States
(12) Patent Application Publication
(10) Pub. No.: US 2003/0091687 A1
(43) Pub. Date: May 15, 2003

(54) Healthy diet system

(76) Inventor: James Bradford Copelan, Santa Clarita, CA (US)

Correspondence Address: Linda Flewellen Gould, Gould & Whitley, Suite 101, 1665 Briargate Boulevard, Colorado Springs, CO, 80920, US

(21) Appl. No.: 09/992,735

(22) Filed: Nov. 13, 2001

(51) Int. Cl. A01K 1/00

(52) U.S. Cl. 426/2

(57) ABSTRACT

A system for assisting a person in establishing and adhering to a healthy diet is described. Each person should determine what consitutes a healthy diet for that particular person, based on education and consultation with a physician or other professional. Appropriate written information for establishing the healthy diet may be provided in the form of a chart. The healthy diet for each person will typically consist of foods which should be eaten, foods which should be eaten only in small quantities, and foods which should be avoided The diet system described herein consists of a series of visual and conditioning aides which can be used together or separately to assist the person in remembering and adhering to the healthy diet appropriate to that person. The visual and conditioning aides include coded labels for affixing to containers of particular foods, coded labels for temporarily affixing to the person's dominant hand, a coded bowl for measuring and serving food, and a coded chart providing diet instructions and coded in a similar manner to the other aides These aides together form an integrated diet system that provides immediate visual awareness and recognition of diet guidelines, biofeedback, aversion recognition of choices adverse to the diet, and a visual conditioning response.

### 1.0 BACKGROUND OF THE INVENTION.

1.1 Technical Field

This invention pertains to a method and related mechanisms for assisting a person in establishing and adhering to a healthy diet, utilizing various labels and other visual and conditioning aides. The invention consists of an integrated diet system that provides immediate visual awareness and recognition of diet guidelines, biofeedback, aversion recognition of choices adverse to the diet, and a visual conditioning response.

1.2 Background Art

Many people need to adhere to a particular food diet. For example, some people have serious food allergies, and need to avoid foods which cause an allergic reaction. Other people have a medical condition such as diabetes, which necessitates eating particular types of foods and avoiding others. Furthermore, a significant number of people in industrialized cultures are overweight, and would benefit from abiding by a diet designed to reduce weight. Although many people crave high sugar, high salt, and high fat foods, such foods can contribute to heart disease, hypertension, and other medical problems.

While the details of each person's beneficial diet may differ from person to person, each diet typically consists of types of food which should be completely avoided, other types of food which should be eaten only in small quantities, and yet another set of food which should be eaten.

While good health is associated with keeping particular diets, cultural conditioning frequently persuades a person to eat foods which that person should avoid, or to eat larger quantities of foods than is healthy. For example, many people rely on fast food restaurants for quick meals, and such restaurants frequently encourage customers to “super-size” particular meal selections. Similarly, consumers are encouraged to buy and eat snack foods which may be detrimental, depending on a particular person's most advantageous diet. A system is needed which will provide immediate visual stimuli to condition and remind individuals to eat foods which are beneficial and avoid foods which are detrimental to them. An integrated diet system that provides immediate visual awareness and recognition of diet guidelines, biofeedback, aversion recognition of choices adverse to the diet, and a visual conditioning response is described herein.

### 2. DISCLOSURE OF THE INVENTION.

2.1 Summary of the Invention

An object of this invention is to provide a method of reminding and encouraging an individual to adhere to the food diet which is most advantageous to that individual. Another object of this invention is to provide such a method which discourages the individual from eating specific foods, or portions of particular foods, which are detrimental to that individual's health.

Yet another object of this invention is to provide such a method which utilizes related mechanisms with similar visual impact, to provide an immediate recognition of the beneficial or detrimental impact of certain foods, through a variety of visual aides.

The healthy diet system claimed herein consists of a number of components which may be used separately or in conjunction with one or more of the other components. Each component will be described separately in this section.

A set of labels may be used to identify foods which are detrimental, advantageous in small quantities, or beneficial. Each label may be advantageously color-coded to provide immediate recognition of whether a particular food is a part of a healthy diet. For example, a warning label to be placed on containers of foods which are detrimental to a particular person may be predominantly red. An alerting label may conveniently be made predominantly yellow, for placement on containers of foods which should be eaten only in moderation. Encouraging labels may be predominantly green, to identify packages containing foods which are advantageous under a particular diet.

Similarly, each label may be coded with words, symbols, or logos which provide immediate recognition of the place of particular food items within the healthy diet. A wide variety of colors, words, symbols, or logos may be used to communicate whether a particular food should be consumed. The labels will be most useful if a particular code of colors, words, symbols, or logos are consistently applied, to provide immediate recognition even as a person reaches for a particular food item.

The labels can be many shapes and sizes, as long as consistent codes are applied to the side of the label which is visible. The reverse side of the label is conveniently provided with an adhesive, to allow the label to be permanently or temporarily affixed to containers of food.

For example, a set of adhesive backed labels with peelable backings may be easily used. It is anticipated that labels with an area approximately three-quarters of an inch to four inches square would fit on many different food containers, while being easily visible.

Once a person's healthy diet has been ascertained, the labels can be applied to packages and containers of food in that person's kitchen and pantry areas, utilizing the appropriately coded labels to identify which foods should be avoided, eaten in moderation, or eaten. Once containers have been so labeled, the labels present an immediate memory device to remind the person whether particular foods should be eaten. Furthermore, encouraging labels create positive reinforcement for eating foods which are beneficial, while alerting and warning labels provide aversion conditioning for eating foods which are detrimental. In this manner, the individual is constantly provided with a memory aide and stimulus for eating within the parameters of that person's ideal diet.

A second component of the healthy diet system claimed herein consist of labels for placing on an individual's dominant hand. Such labels may be adhesive backed removable labels, or transparencies such as temporary tattoos. Each such label can present a code, in the form of a color, word, symbol, logo, or combination thereof, which reminds the individual not to eat foods which are contrary to his or her healthy diet. The code will be most powerful if it corresponds to the code used on the warning, alerting, or encouraging labels placed on food containers. As the person reaches for a particular food item, the label on top of his or her dominant hand will provide a reminder to eat foods which are part of the healthy diet.

A specialized bowl or container forms a third component of the healthy diet system claimed herein. The bowl is segmented into compartments intended to hold particular types of foods. For example, one compartment might be designed to hold any of a variety of starches, while another compartment would be utilized for any type of vegetable. Each compartment is coded to identify the types of food to be placed in that compartment. Each compartment is also sized to hold an appropriate portion of the type of food to be placed in that compartment. It is most advantageous if the codes used to identify types of food in the partitioned bowl related to codes used for labels or on a chart utilized in other parts of the healthy diet system.

A fourth component of the healthy diet system is a chart providing written instructions for complying with an individual's healthy diet. This chart will be most useful if it utilizes the same codes as labels placed on food containers or the individual's hand. For example, a chart could contain a list of foods which are encouraged as a part of the healthy diet, prominantly displaying the code appearing on encouraging labels with that list of foods. Similarly, a list of foods to be avoided could be listed on the chart together with the code appearing on warning labels affixed to food containers. The chart could conveniently provide other information as well, including information regarding appropriate quantities of food to consume, nutritional information, meal plans, and exercise information.

It is apparent that each component of this healthy diet system can be utilized without using the other components, to provide a significant memory aide and stimulus for healthy eating. When two or more of the components of the system are used in conjunction with each other, the similar codes used for visual recognition become more powerful, providing instant communication of what is healthy and encouragement to abide by the healthy diet.

The novel features that are considered characteristic of the invention are set forth with particularity in the claims. The invention itself, both as to its construction and its method of operation, together with additional objects and advantages thereof, will best be understood from the description of specific embodiments which follows, when read in conjunction with the accompanying drawings.

### 2.2 BRIEF DESCRIPTION OF THE DRAWINGS

FIG. 1 is a perspective view of food containers to which labels have been attached according to the present invention.

FIG. 2 is a front view of a label according to the present invention.

FIG. 3 is a top view of a person's hand to which a label or temporary tattoo has been affixed, according to the present invention.

FIG. 4 is a perspective view of a partitioned bowl, according to the present invention.

FIG. 5 is a front view of a chart, according to the present invention.

### 2.3 DETAILED DESCRIPTION OF THE PREFERRED EMBODIMENT

The present invention concerns a method and related apparati for assisting a person in establishing and adhering to a healthy diet. In the following description, numerous specific details are set forth in order to provide a thorough understanding of the present invention. It will be obvious, however, to one skilled in the art that the present invention may be practiced without these specific details. Some well-known methods and structures have not been set forth in order not to unnecessarily obscure the description of the present invention.

The healthy diet system consists of four components, each of which may be effectively used separately. However, when an individual utilizes two or more components in the diet process, the effectiveness of each individual component is exponentially strengthened. Each component provides a reminder of foods to be avoided, foods to be eaten in moderation, and foods to be encouraged as a part of that individual's particular healthy diet. By using a coherent system of reminders which are similar in color, symbolism, or shape, each reminder becomes a more powerful tool. As the healthy diet process is used, reminders appearing in a variety of places provide positive reinforcement of healthy diet choices, and aversion conditioning for unhealthy diet choices.

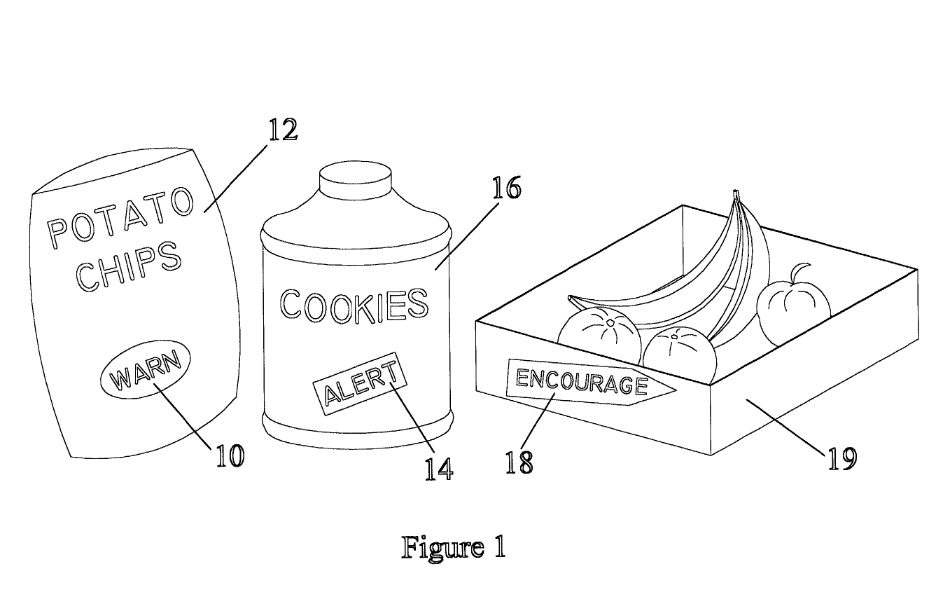

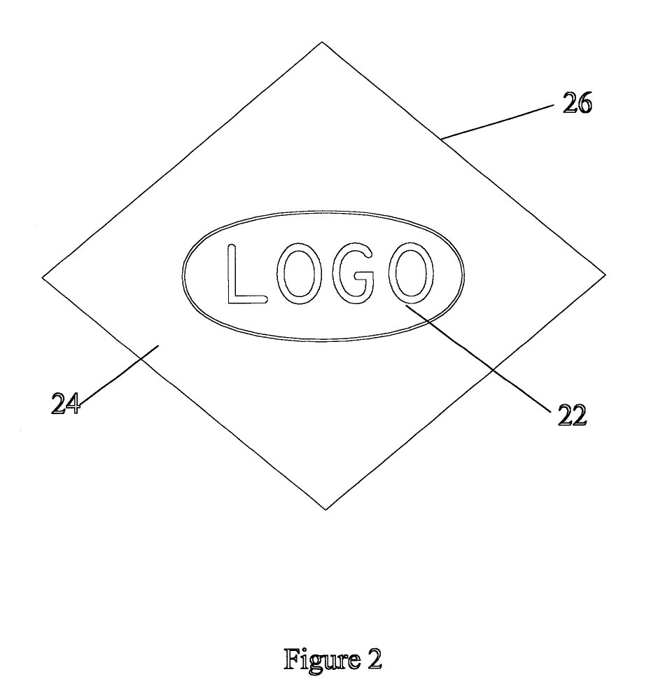

FIG. 1 illustrates a series of labels 10, 14, 18, which can be affixed to containers 12, 16, 19 of food. Each label 10, 14, 18 has a front side 24 and a back side 26 as shown in FIG. 2. The back side 26 is coated with a temporary or permanent adhesive (not shown), as is commonly available. It is convenient to provide such labels 10,14, 18 with a peelable backing (not shown), so the backing can be easily removed, exposing the adhesive, and allowing the label 10, 14, 18 to be simply attached to food containers 12, 16, 19.

Each person can determine what constitutes an appropriate diet for that person through education, professional counsel, or other sources of information. The healthy diet for that individual will consist of foods which should be avoided, foods which should be eaten in moderation, and foods which should be encouraged. The first step in the healthy diet process is to affix warning labels 10 on containers 12 of foods which should be avoided. Similarly, alerting labels 14 should be applied to containers 16 of foods which should be eaten in small quantities. The individual can be reminded and encouraged to eat foods which are good for them by placing encouraging labels 18 on containers 19 of healthy foods. Thus, as illustrated in FIG. 1, the individual's food choices are clearly marked with reminders of the pre-determined healthy diet.

Each label 10, 14, 18 is coded to establish whether it is marking a food to be avoided, food to be eaten in moderation, or food to be encouraged. The code can be as simple as a logo 22 printed on top of the label 10, 14, 18. For example, a picture of a svelte person might be an appropriate code 22 to adorn an encouraging label 18 for a person whose diet seeks to reduce weight. A skull and cross-bones symbol, or a picture of an obese person, might serve as an appropriate code 22 to place on a warning label 10 associated with the same diet. For ease in recognition, it is convenient to color code each label 10, 14, 18. For example, all warning labels 10 might be red, alerting labels 14 might be yellow, and encouraging labels 18 might be green.

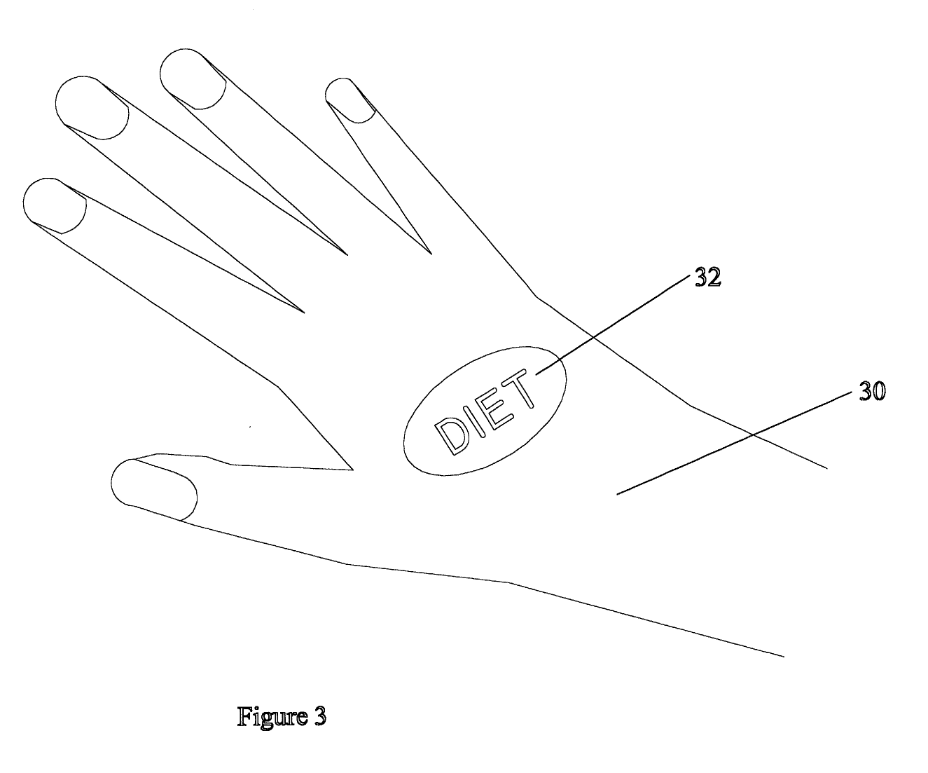

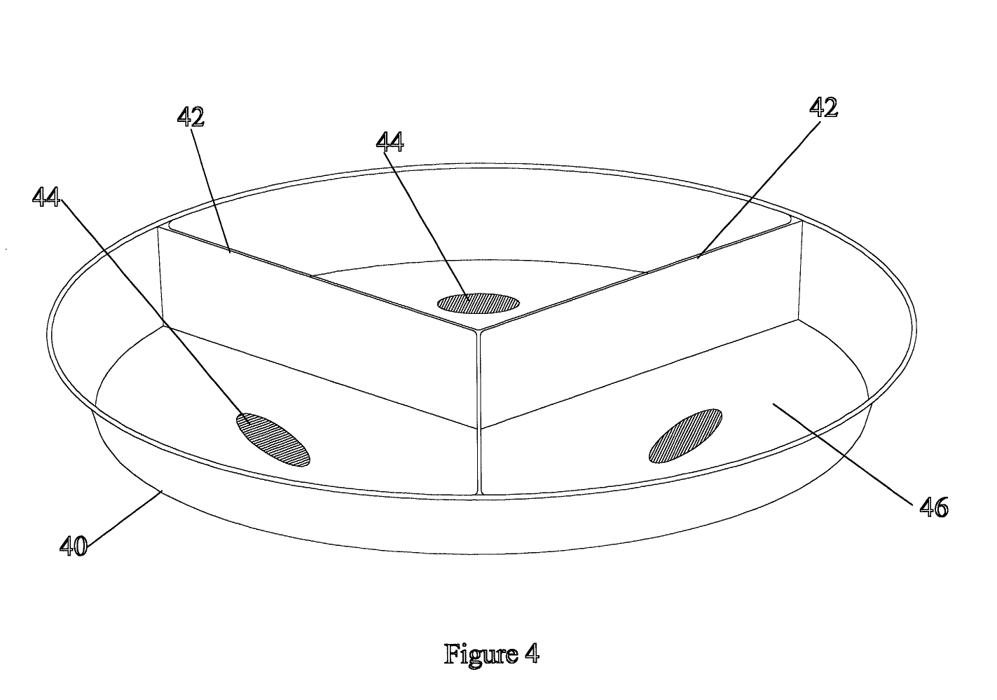

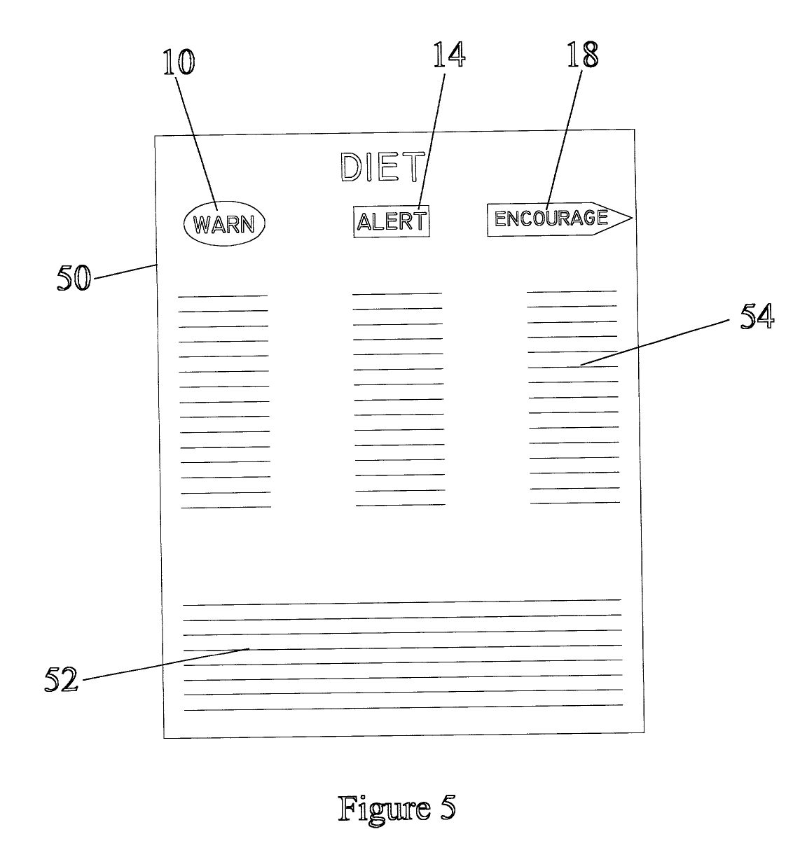

Similar labels or temporary tattoos 32 are utilized in the second component of the healthy diet system. In this component, labels or temporary tattoos 32 are temporarily affixed to the top of the dominant hand 30 of an individual, as shown in FIG. 3. It would be appropriate to use a warning label 10 or an alerting label 14 for this purpose. In this manner, the individual is warned, each time they reach for food, to remember the healthy diet and make choices in keeping with that diet. The label or tattoo 32 serves as a memory aide, and a visual stimulus for complying with the healthy diet. The stimulus is most effective when used with other components of the healthy diet system, as the label or tattoo 32 has stronger impact when it is associated with labels 10, 14, 18 placed on food containers, compartments 46 of a bowl 40 as shown in FIG. 4, or headings in a chart 50 as shown in FIG. 5.

Serving food in a bowl or container 40 shown in FIG. 4 may be an additional step in the healthy diet process. The bowl 40 is compartmentalized by partitions 42, to form separate segments 46 of the bowl 40. Each segment 46 is color coded or coded with a symbol 44 to indicate the type of food to be placed in that segment 46 For example, foods to be eaten in moderation might be placed in a segment 46 of the bowl 40 which is yellow in color, corresponding to the color of alerting labels 14 used in other steps of the healthy diet process.

The bowl 40 is ideally sized to accomodate healthy amounts of each food type. For example, the partitions 42 can be arranged to create a segment 46 which will hold the number of ounces of protein which is appropriate to the healthy diet of certain individuals. Another segment 46 may be sized to hold the number of ounces of starch would should be consumed by that same individual in a meal. Food can then be served in the individual segments 46, assuring the individual that the portions served adhere to the healthy diet for that individual.

Another step in the healthy diet process claimed herein utilizes a chart 50 as shown in FIG. 5. The chart 50 can contain information 52 which provides details about a particular diet. Indeed, the chart 50 may provide the initial information required to establish the healthy diet for particular types of people. For example, one chart 50 might be designed to provide healthy diet information for over-weight people. The chart 50 may also conveniently list foods which should be avoided, eaten in moderation, or encouraged, heading each list 54 with an appropriate code such as a warning label 10, alerting label 14, and encouraging label 18. Repetitive use of the codes appearing on the labels 10, 14, 18 in other formats such as the chart 50 serves to increase the effectiveness of these memory aides and stimuli to healthy eating.

The novel healthy diet system has been described in detail with particular reference to preferred embodiments thereof. As will be apparent to those skilled in the art in the light of the accompanying disclosure, many substitutions, modifications, and variations are possible in the practice of the invention without departing from the spirit and scope of the invention.

I claim:

1. A process for assisting a person in establishing and adhering to a healthy diet, comprising the steps of:
a. obtaining at least one two-sided warning label, having an adhesive on a lower side and having a warning symbol on an upper side,
b. placing said warning label on a container containing food which is not conducive to the healthy diet.

2. A process according to claim 1, wherein said label is removable.

3. A process according to claim 1, further comprising:
c. obtaining at least one two-sided encouraging label, having an adhesive on a lower side and having an encouraging symbol on an upper side,
d. placing said encouraging symbol on a container containing food which is conducive to the healthy diet.

4. A process according to claim 3, further comprising:
e. obtaining at least one two-sided alerting label, having an adhesive on a lower side and having an alerting symbol on an upper side,
f. placing said alerting symbol on a container containing food which is not conducive to the healthy diet if consumed in significant quantities.

5. A process according to claim 4, wherein said warning symbol is predominantly red, said encouraging symbol is predominantly green, and said alerting symbol is predominantly yellow.

6. A process for assisting a person in adhering to a healthy diet, comprising the steps of:
a. obtaining at least one two-sided alerting label, having a temporary adhesive on a lower side and having an alerting symbol on an upper side,
b. placing said alerting symbol on top of the dominant hand of the person.

7. A process according to claim 4, further comprising:
g. obtaining at least one two-sided alerting label, having a temporary adhesive on a lower side and having an alerting symbol on an upper side,
h. placing said alerting symbol on top of the dominant hand of the person.

8. A process for assisting a person in adhering to a healthy diet, comprising the step of:
a. applying a temporary tattoo having an alerting symbol on top of the dominant hand of the person.

9. An apparatus for assisting a person in adhering to a healthy diet, comprising:
at least one two-sided warning label, having an adhesive on a lower side and having a warning symbol on an upper side, suitable for placing on a container containing food which is not conducive to the healthy diet.

10. An apparatus according to claim 9, further comprising:
a plurality of two-sided warning labels, each having an adhesive on a lower side, and each having a warning symbol, or an alerting symbol, or an encouraging symbol on an upper side.

11. An apparatus for assisting a person in establishing and adhering to a healthy diet, comprising:
a partitioned bowl, each partitioned segment bearing a symbol identifying a particular food group, each segment of a size appropriate to contain a desirable amount of the food group identified by the symbol applicable to that segment.

12. A process according to claim 4, further comprising:
g. serving food to the person in a partitioned bowl, each partitioned segment bearing a symbol identifying a particular food group, each segment of a size appropriate to contain a desirable amount of the food group identified by the symbol applicable to that segment.

13. A process according to claim 7, further comprising:
i. serving food to the person in a partitioned bowl, each partitioned segment bearing a symbol identifying a particular food group, each segment of a size appropriate to contain a desirable amount of the food group identified by the symbol applicable to that segment.

14. A process according to claim 4, further comprising:
g. providing a chart with printed instructions regarding the healthy diet,
h. affixing a symbol substantially similar to said warning label to said chart to identify foods not conducive to the healthy diet,
i. affixing a symbol substantially similar to said encouraging label to said chart to identify foods conducive to the healthy diet, and
j. affixing a symbol substantially similar to said alerting label to said chart to identify foods not conducive to the healthy diet if consumed in significant quantities.

15. A process according to claim 7, further comprising:
i. providing a chart with printed instructions regarding the healthy diet,
j. affixing a symbol substantially similar to said warning label to said chart to identify foods not conducive to the healthy diet,
k. affixing a symbol substantially similar to said encouraging label to said chart to identify foods conducive to the healthy diet, and
l. affixing a symbol substantially similar to said alerting label to said chart to identify foods not conducive to the healthy diet if consumed in significant quantities.

16. A process according to claim 13, further comprising:
j. providing a chart with printed instructions regarding the healthy diet,
k. affixing a symbol substantially similar to said warning label to said chart to identify foods not conducive to the healthy diet,
l. affixing a symbol substantially similar to said encouraging label to said chart to identify foods conducive to the healthy diet, and
m. affixing a symbol substantially similar to said alerting label to said chart to identify foods not conducive to the healthy diet if consumed in significant quantities.
